(19) United States
(12) Patent Application Publication
(10) Pub. No.: US 2022/0205840 A1
(43) Pub. Date: Jun. 30, 2022

(54) METHOD FOR FABRICATING AN OPTICAL SOURCE FOR CALIBRATING AN OPTICAL SYSTEM

(71) Applicant: UNIVERSITY OF CENTRAL FLORIDA RESEARCH FOUNDATION, INC., Orlando, FL (US)

(72) Inventors: Romain GAUME, Orlando, FL (US); Matthew JULIAN, Merritt Island, FL (US); Matthieu BAUDELET, Orlando, FL (US)

(21) Appl. No.: 16/429,423

(22) Filed: Jun. 3, 2019

(51) Int. Cl. G01J 3/02; G01N 21/71; G01N 21/65; G01J 3/443

(52) U.S. Cl. CPC G01J 3/0297; G01N 21/718; G01N 2201/12784; G01J 3/443; G01N 21/65

(57) ABSTRACT

A method for fabricating an optical source for calibrating an optical system is provided. The method includes determining a form factor for an optical source based on a point of detection of an optical system corresponding to a region where an optical signal of the optical system interacts with a sample. The method also includes providing an envelope in a size and shape to fit the form factor. The method also includes providing a plurality of electrodes connected to the envelope for connection to a power source and filling the envelope with a gas. The optical source formed from the above method is also provided.

### STATEMENT OF GOVERNMENTAL INTEREST

This invention was made with government support under Contract No. FA9550-18-1-0103 awarded by the Department of Air Force Office of Scientific Research (AFOSR). The government has certain rights in the invention.

### BACKGROUND

Operation of optical systems, including systems employing emission spectroscopy, involving radiating all or part of a sample with an optical signal from an optical source. The sample subsequently emits radiation that is measured by a detector of the optical system. The measured radiation is then analyzed by a processor of the optical system to determine one or more characteristics of the sample.

### SUMMARY

Techniques are provided for calibrating one or more parameters of optical systems, including optical systems employing emission spectroscopy. The inventors of the present invention recognized that although optical systems with spectral detectors should be calibrated according to spectrum and intensity prior to use, many such conventional optical systems are not calibrated. The inventors recognized this is because conventional optical calibration sources are not available which fit the region where the optical signal interacts with the sample. The inventors of the present invention observed that conventional optical calibration sources are relatively large and bulky, requiring additional components such as integrating spheres, and thus are too large to fit in the relatively small region in many optical systems where the signal is acquired. Since these optical systems are not calibrated according to spectrum and intensity, the inventors of the present invention recognized that they have limited accuracy, such as in chemical calibration (e.g. calculating calibration curves for different materials) and identifying a relative amount of chemicals in a sample (e.g. using the calibration curves).

The inventors of the present invention also recognized that since the conventional optical calibration sources are relatively large and bulky, even if they are used to calibrate optical systems, they generate calibration beams that are too wide to accurately represent a near point source of the radiated sample in optical systems employing emission spectroscopy. Thus, the inventors of the present invention noticed that even when conventional optical calibration sources are used, they do not provide effective spectral or intensity calibration of the optical system.

Based on these observations, the inventors of the present invention developed a method for fabricating an optical source to calibrate an optical system including an optical system employing emission spectroscopy. The method adapts the optical source to the point of detection or region where the optical beam interacts with the sample in the optical system. Thus, the optical source accommodates the region of the optical system where the optical beam interacts with the sample. Additionally, the optical source generates a beam whose characteristics (e.g. shape, dimension, divergence, spectrum, etc.) accurately represents one or more corresponding characteristics of the near point source of the radiated sample in the optical system.

In a first set of embodiments, a method for fabricating an optical source for calibrating an optical system is provided. The method includes determining a form factor for an optical source based on a point of detection of an optical system corresponding to a region where an optical signal of the optical system interacts with a sample. The method also includes providing an envelope in a size and shape to fit the form factor. The method also includes providing a plurality of electrodes connected to the envelope for connection to a power source and filling the envelope with a gas.

In a second set of embodiments, a method for using the optical source to calibrate an optical system is provided. The method includes positioning the optical source at the point of detection of the optical system and connecting, with a cable, a plurality of connectors of the respective the plurality of electrodes to a power source. The method also includes transmitting, with a processor, a signal to the plurality of electrodes to cause the gas to emit radiation through the envelope with an emission spectrum over a spectral region. The emission spectrum includes a continuous spectrum with an expected intensity and a plurality of discrete emission lines superimposed on the continuous spectrum at a respective plurality of expected wavelengths. The method also includes measuring, with a detector of the optical system, a detected intensity of the continuous spectrum and/or a plurality of detected wavelengths of the plurality of discrete emission lines. The method also includes determining, with the processor, an intensity calibration curve over the spectral region based on a closest fit of the detected intensity and the expected intensity of the continuous spectrum. The method also includes determining, with the processor, a wavelength calibration curve over the spectral region based on a closest fit of the detected wavelength and the expected wavelength of the discrete emission lines.

In a third set of embodiments, an optical source for calibrating an optical system is provided. The optical source includes an envelope with a size and a shape to fit a form factor, where the form factor is based on a point of detection of the optical system corresponding to a region where an optical signal of the optical system interacts with a sample. The optical source also includes gas within the envelope, where the gas has an emission spectrum comprising a continuous spectrum and a plurality of discrete emission lines superimposed on the continuous spectrum in a wavelength range of radiation emitted by the sample in the optical system. The optical source also includes a first and second electrode connected to respective first and second ends of the envelope and configured to be connected to a power source to provide a voltage difference for ionization the gas between the first and second ends.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is a block diagram that illustrates example components of an optical system employing emission spectroscopy, according to an embodiment;

FIG. 1B is a block diagram that illustrates example components for calibrating the optical system of FIG. 1A where an optical calibration source replaced the sample, according to an embodiment;

FIG. 1C is a graph that illustrates an example chemical calibration curve of the optical system of FIG. 1A, according to an embodiment;

FIG. 2A is a block diagram that illustrates example components of the optical calibration source of FIG. 1B, according to an embodiment;

FIG. 2B is a block diagram that illustrates a top view of one end of the envelope of the optical calibration source of FIG. 2A, according to an embodiment;

FIG. 2C is a block diagram that illustrates a cross-sectional view taken along line 2C-2C in FIG. 2B, according to an embodiment;

FIG. 3A is an image that illustrates a top perspective view of example components of the optical calibration source of FIG. 1B, according to an embodiment;

FIG. 3B is an image that illustrates a top view of example components of the optical calibration source of FIG. 1B, according to an embodiment;

FIG. 3C is an image that illustrates a top view of example components of the optical calibration source of FIG. 1B connected to a power supply with a cable, according to an embodiment;

FIG. 4 is a schematic diagram that illustrates example components of a laser induced breakdown spectroscopy (LIBS) system, according to an embodiment;

FIG. 5 is a schematic diagram that illustrates example components of a Raman spectroscopy system, according to an embodiment;

FIG. 6A is a graph that illustrates an example expected spectrum of the optical calibration source of FIG. 1B, according to an embodiment;

FIG. 6B is a graph that illustrates an example detected spectrum of the optical calibration source of FIG. 1B, according to an embodiment;

FIG. 6C is a graph that illustrates an example wavelength calibration curve of the optical system of FIG. 1A, according to an embodiment;

FIG. 6D is a graph that illustrates an example intensity calibration curve of the optical system of FIG. 1A, according to an embodiment;

FIG. 6E is a graph that illustrates an example detected and corrected spectrum of a material using the calibrated optical system of FIG. 1A, according to an embodiment;

FIG. 7 is a graph that illustrates an example emission spectrum of Xenon gas according to an embodiment;

FIG. 8A is a flow chart that illustrates an example method for fabricating an optical source for calibrating an optical system, according to an embodiment;

FIG. 8B is a flow chart that illustrates an example method for using an optical source to calibrate an optical system, according to an embodiment;

FIG. 9 is a block diagram that illustrates a computer system upon which an embodiment of the invention may be implemented; and

FIG. 10 illustrates a chip set upon which an embodiment of the invention may be implemented.

### DETAILED DESCRIPTION

A method and apparatus are described for calibrating an optical system. A method is also provided for fabricating an optical source for calibrating an optical system. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of optical systems including optical systems employing emission spectroscopy. In one embodiment, the invention is described below in the context of laser induced breakdown spectroscopy (LIBS) systems. In other embodiments, the invention is described below in the context of Raman Spectroscopy systems. However, the invention is not limited to this context. In other embodiments, other atomic emission spectroscopies use the source, including induction coupled plasma atomic emission spectroscopy (ICP-AES) and flame, arc and spark emission spectroscopy. In yet other embodiments, optical spectroscopy techniques, such as fluorescence spectroscopy and Nuclear-fusion-induced spectroscopy use the source.

### 1. Overview

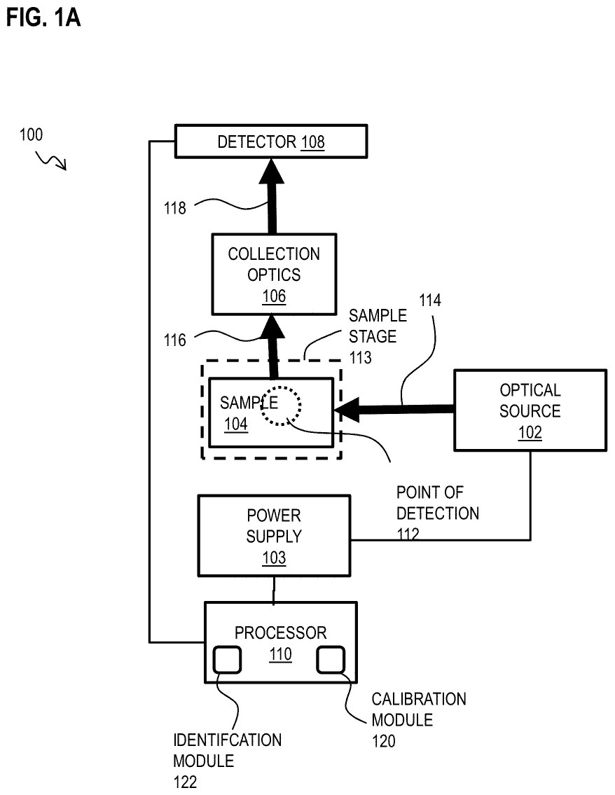

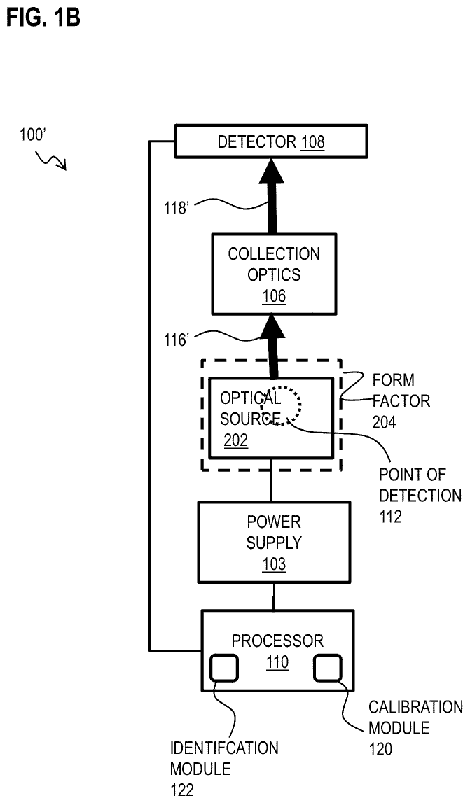

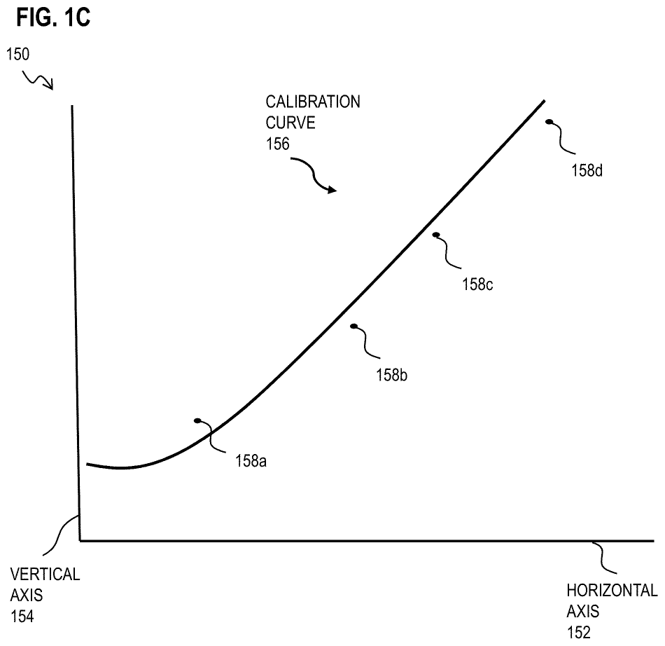

FIG. 1A is a block diagram that illustrates example components of an optical system 100 employing emission spectroscopy, according to an embodiment. In an embodiment, the optical system 100 includes an optical source 102 (e.g. laser) that emits a beam 114 at a region or point of detection 112 where a sample 104 is positioned. In one embodiment, a processor 110 transmits a signal to a power supply 103 that is connected to the optical source 102, where the power supply 103 provides power to the optical source 102 so that the beam 114 is emitted from the optical source 102. In an embodiment, the beam 114 interacts with the sample 104 (e.g. is sampled and/or excites the sample 104) in a volume or region defining a point of detection 112. In some embodiments, the point of detection 112 encloses the sample 104. In other embodiments, the point of detection 112 only encloses that portion of the sample 104 interacting with the beam 114 (e.g. ablated portion of the sample 104) and/or irradiating an optical signal 116 based on the interaction of the sample 104 with the beam 114. In one example embodiment, the point of detection 112 models a near point source. In another example embodiment, the point of detection 112 has a volume not greater than a couple of centimeters in width (e.g. from about 1 cm to about 10 cm), such as in ICP-AES.

In an embodiment, the optical signal 116 emitted by the sample 104 is shaped by collection optics 106. In some embodiments, the collection optics 106 includes one or more shaping optics (e.g. lens, mirror, etc.) and/or a dispersion optic (e.g. diffraction grating, prism, etc.) that disperses the optical signal 116 spatially based on wavelength. The collected optical signal 118 is incident on a detector 108 (e.g. spectrometer) that detects the wavelength and intensity of the dispersed optical signal 118 and transmits this detection data to a processor 110.

In some embodiments, the sample 104 is made from a known ratio of elements and/or known elements and the system 100 is configured to analyze one or more atomic spectral lines of the collected optical signal 118. In these embodiments, the processor 110 includes a calibration module 120 to perform chemical calibration where the processor 110 calculates a ratio of the intensity of the atomic emission lines in the collected optical signal 118 corresponding to the elements. The processor 110 stores this intensity ratio along with the known ratio (e.g. percentage) of the elements in a memory of the processor 110. This is repeated for multiple samples 104 with different known ratios of the elements. In an embodiment, the processor 110 then derives a calibration curve that fits this data with the intensity ratio of the elements on one axis and the known ratio of the elements on another axis.

FIG. 1C is a graph 150 that illustrates an example chemical calibration curve 156 of the optical system 100 of FIG. 1A, according to an embodiment. The horizontal axis 152 is intensity ratio (unit less) of the atomic spectral lines of the collected optical signal 118 between two elements in the sample 104 (e.g. elements A and B). The vertical axis 154 is the known ratio between two elements in the sample 104 (e.g. elements A and B). Data points 158a, 158b, 158c, 158d indicate data from four different samples 104. In an embodiment, the processor 110 determines the calibration curve 156 using a closest fit (e.g. small order polynomial, least squared, etc.) model of the data points 158a, 158b, 158c, 158d. Although four data points are depicted in FIG. 1C, fewer or more than four data points may be employed to determine the calibration curve. In one embodiment, the calibration curve 156 is stored in a memory of the processor 110. In an embodiment, the instructions of the calibration module 120 are repeated for multiple pairs of elements within each sample 104 and/or for multiple samples 104 with different elements, so that the memory of the processor 110 includes calibration curves 156 for different samples with different elements.

In some embodiments, the processor 110 includes an identification module 122 that is used to identify an unknown ratio of elements in a sample 104 with known elements. In an embodiment, the detector 108 measures the atomic emission lines of the collected optical signal 118 and transmits this detection data to the processor 110. In an embodiment, the processor 110 then calculates the intensity ratio between the emission lines between two elements (e.g. elements A and B). In an embodiment, the processor 110 then retrieves the calibration curve 156 from the memory for the sample 104 based on the known elements in the sample. The processor 110 uses the calculated intensity ratio between the emission lines as an input to the calibration curve 156 to determine the corresponding ratio of elements (e.g. value along the vertical axis 154 corresponding to the calculated intensity ratio along the horizontal axis 152). The processor 110 then determines that the ratio of elements in the sample 104 corresponds to the retrieved value of the calibration curve 156. In some embodiments, a signal is transmitted from the processor 110 to a device (e.g. display 914) to output the ratio of elements in the sample 104 to a user of the system 100.

FIG. 1B is a block diagram that illustrates example components for calibrating the optical system 100′ of FIG. 1A where an optical calibration source 202 replaces the sample 104, according to an embodiment. In this embodiment, the optical calibration source 202 is placed in the system 100′ to calibrate the response of the collection optics 106 and the detector 108. This calibration accounts for spectral and intensity shifts in the detected spectrum of the collected optical signal 118 due to characteristics of the detector 108 and/or the collection optics 106. The inventors of the present invention recognized that the spectral and intensity calibration of the detector 108 provides several advantages in the operation of the system 100, including increased accuracy in the measurement of the wavelengths and intensities of the emission lines in the collected optical signal 118 spectrum. In one example embodiment, the inventors of the present invention realized that unless the system 100 is calibrated according to spectrum and intensity, it is difficult to distinguish whether a detected peak intensity at a particular wavelength is a high intensity emission line of a relatively low proportional element in a sample or is a low intensity emission line of a relatively high proportional element in a sample. Thus, the calibration provided by the optical source 202 ensures that such a distinction can be made. One particular advantage involves increased accuracy in the calculation of intensity ratios and in the wavelength values of each element in the determination of the calibration curve 156 during chemical calibration. Another particular advantage involves increased accuracy in the measured intensity ratio and wavelength values of the collected optical signal 118 emission during the identification of an unknown ratio of elements in the sample 104, even if the elements in the sample 104 are unknown.

In an embodiment, the optical source 202 has a form factor 204 that is based on the sample stage 113 for the system 100. In some embodiments, the form factor 204 is configured so that an optical signal116′ emitted from the optical source 202 has one or more characteristics (e.g. width, shape, intensity, wavelength range, etc.) that is based on one or more equivalent characteristics of the point of detection 112 or optical signal 116 radiated by the sample 104 during operation of the system 100. In one example embodiment, the values of the one or more characteristics of the optical signal 116′ from the optical source 202 are within ±10% of the values of the equivalent characteristics of the optical signal 116 from the sample 104. In yet another embodiment, a wavelength range of the optical signals116, 116′ is from deep ultraviolet (UV) to medium wavelength infrared (MWIR). In some embodiments, the wavelength range of the optical signals 116, 116′ is only limited by the transmission through the medium surrounding the sample 104 (e.g. air, moist air, vacuum, water, etc.). In other embodiments, the wavelength range of the optical signals 116, 116′ is limited by the collection optics 106 due to the transmissivities of the optical components (e.g. high UV-grade silica fibers have transmission window from about 180 nm to about 3 μm, CaF₂ optics have transmission window from about 120 nm to about 7.5 μm in a free-space propagation mode, etc.). In one example embodiment, the wavelength range of the optical signals 116, 116′ extends from about 180 nm to about 2 μm and/or from about 100 nm to about 8 μm. In some embodiments, one or more dimensions of the form factor 204 are about equal to the equivalent dimensions of the point of detection 112 or the sample stage 114. In other embodiments, the form factor 204 is larger than and encloses the point of detection 112. In some embodiments, the form factor 204 includes the optical source 202 and additional components related to operation of the optical source 202 (e.g. housing for the optical source, electrodes, etc.). In an example embodiment, the form factor 204 has dimensions in a range from about 1 centimeter (cm) to about 10 cm and/or from about 0.5 cm to about 20 cm.

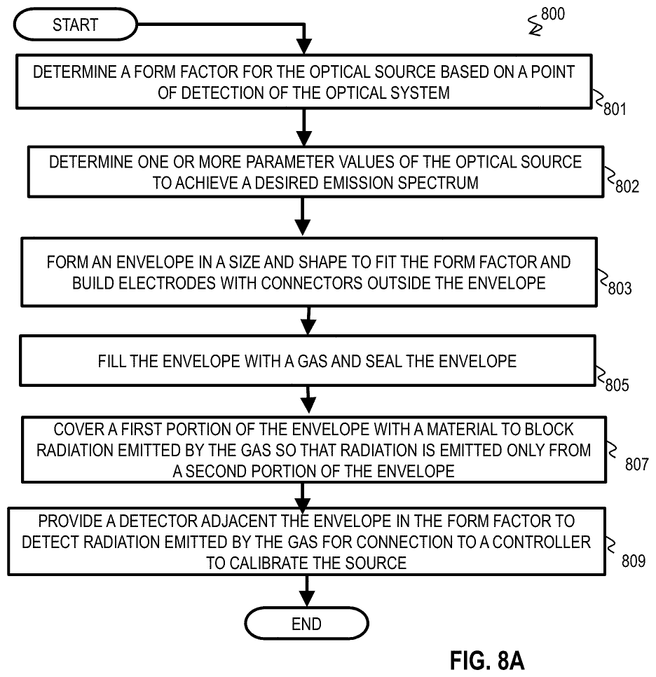

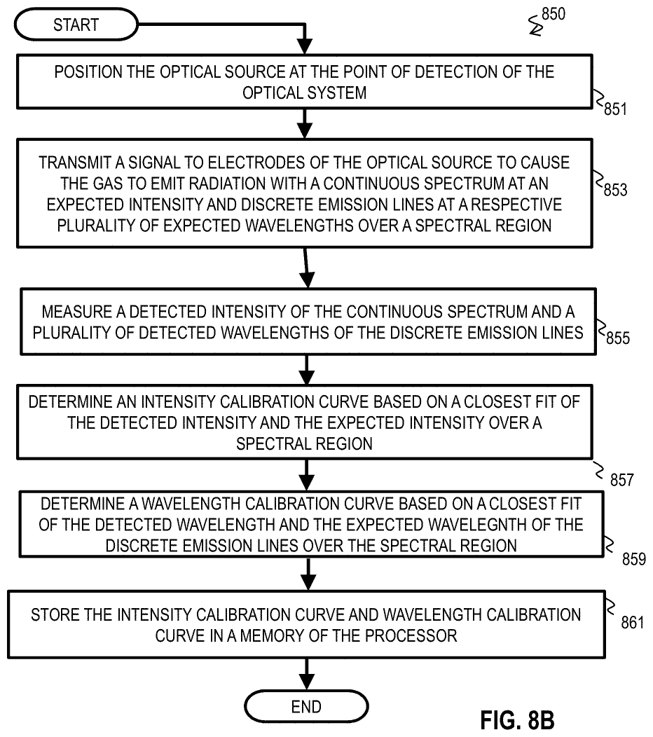

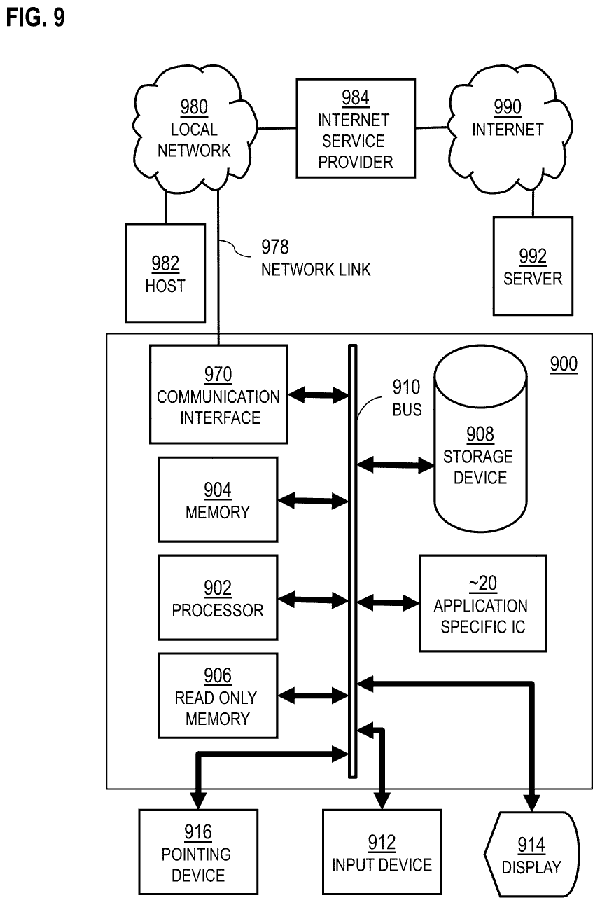

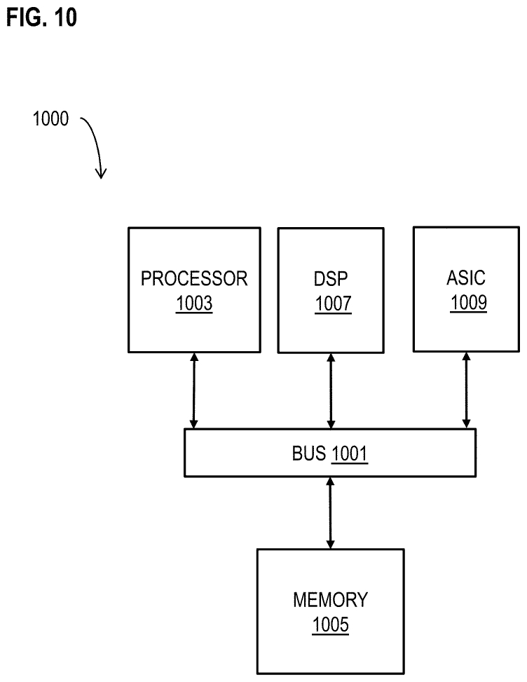

The optical signal 116′ emitted by the optical source 202 is shaped by the collection optics 106. The collected optical signal 118′ based on source 202 is incident on the detector 108 (e.g. spectrometer) that detects the wavelength and intensity of the collected optical signal 118′ and transmits this detection data to the processor 110. The detection data is made available to the processor 110, such as a computer system 900 described below with reference to FIG. 9, or a chip set 1000 described below with reference to FIG. 10. A calibration module 114 includes instructions to perform one or more steps of the method 850 related to the flowchart of FIG. 8B.

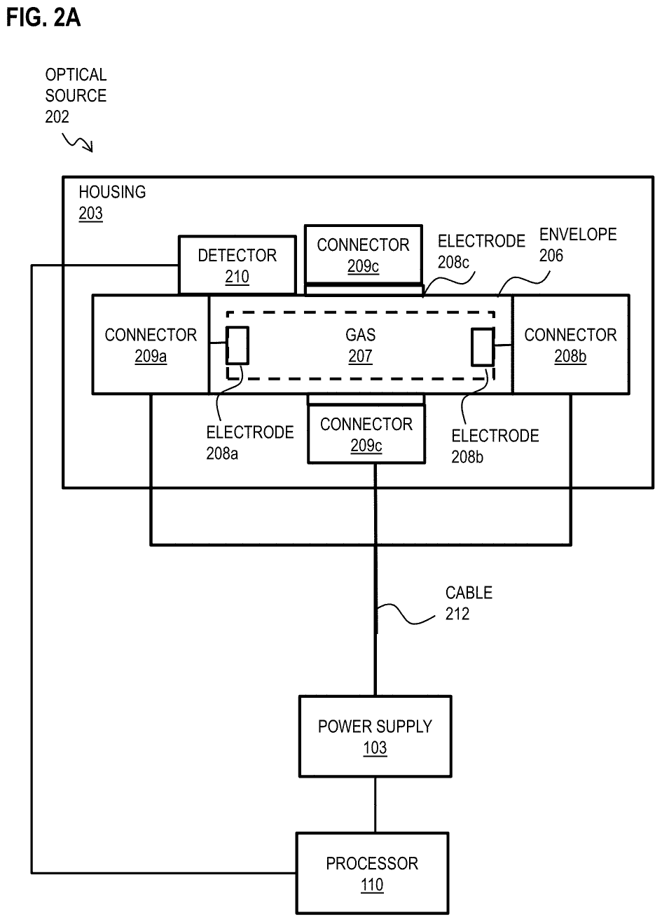

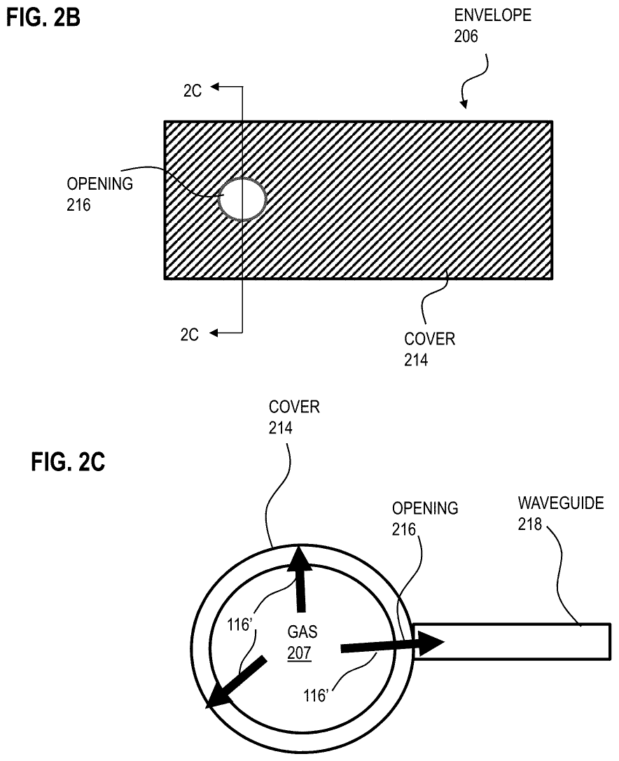

FIG. 2A is a block diagram that illustrates example components of the optical calibration source 202 of FIG. 1B, according to an embodiment. In an embodiment, the optical source 202 includes a housing 203 that holds the components of the source 202 and fits the form factor 204. In one example embodiment, the housing 203 defines the form factor 204. In another example embodiment, the housing 203 is sized based on a slot or opening, called herein the sample stage 113, adjacent the point of detection 112 and/or based on a base or platform on which the sample 104 is positioned in the system 100. In some embodiments, the housing 203 is excluded.

The optical source 202 includes an envelope 206 (e.g. gas filled discharge tube) that is formed with a size and shape to fit the form factor 204 and/or the housing 203. In an embodiment, the envelope 206 is made from a material that is transmissive over a wavelength range of a target optical signal 116 from sample 104 of interest. This advantageously ensures that the optical source 202 is capable of replicating the spectrum of the optical signal 116 emitted from the sample 104 in the system 100. In one embodiment, a first electrode 208a and second electrode 208b are positioned within the envelope 206 adjacent respective first and second ends of the envelope 206. In this embodiment, the first and second electrodes 208a, 208b are connected to respective first and second connectors 209a, 209b outside of the envelope 206 so that the first and second connectors 209a, 209b can be connected to an external power supply 103. In other embodiments, the first and second electrodes 208a, 208b are positioned external to the envelope 206 (e.g. along an external surface of the envelope 206 adjacent the first and second ends). In one embodiment, the first and second electrodes 208a, 208b are polarized with respect to each other, so that they initiate ionization of the gas 207 when a sufficient potential difference is established between the electrodes 208a, 208b. Although FIG. 2A depicts that the first and second connectors 209a, 209b are positioned adjacent the first and second ends of the envelope 209, in other embodiments they can be positioned elsewhere with respect to the envelope 206.

In some embodiments, a third electrode 208c is provided along an exterior of the envelope 206 between the first and second ends of the envelope 206. In these embodiments, the third electrode 208c is connected to a third connector 209c that can be connected to an external power supply 103. In an embodiment, the third electrode 208c provides a trigger voltage (e.g. with a magnitude smaller than the potential difference between the electrodes 208a, 208b) in order to facilitate an initiation of radial discharge of the ionized gas 207 in the envelope 206.

In an embodiment, an interior of the envelope 206 is filled with gas 207 after which the envelope 206 is sealed. In one embodiment, the gas 207 is selected so that an emission spectrum of the gas 207 corresponds at least in wavelength range and approximate intensity to the emission spectrum of the target optical signal 116 from the sample 104 of interest. This advantageously ensures that the optical source 202 is capable of approximating or replicating the spectrum of the target optical signal 116 emitted from the sample 104 of interest in the system 100. In some embodiments, one or more parameters (gas, voltage differences, etc.) of the optical source 202 are selected (e.g. theoretically or empirically) so to achieve an expected emission spectrum from the optical source 202. In one embodiment, the expected emission spectrum corresponds to an emission spectrum of the spectrum of the target optical signal 116 emitted from the sample 104 of interest in the system 100. In an example embodiment, the one or more parameters of the optical source 202 are empirically determined by cross checking the optical source 202 against a secondary source with a known emission spectrum (e.g. certifying with National Institute of Standards and Technology, NIST®). In various embodiment, the parameters of the optical source 202 that are selected include one or more of the type of gas 207; one or more dimensions of the envelope 206 (e.g. including interior dimensions of the interior cavity of the envelope 206); material used to make the envelope 206; electrical connections between the electrodes 208 and the connectors 209 and a potential difference applied between the electrodes 208a, 208b.

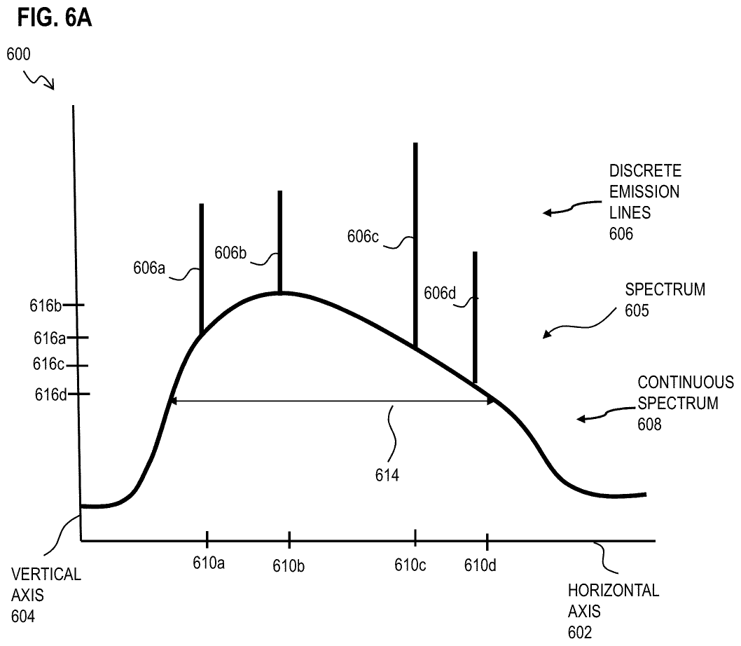

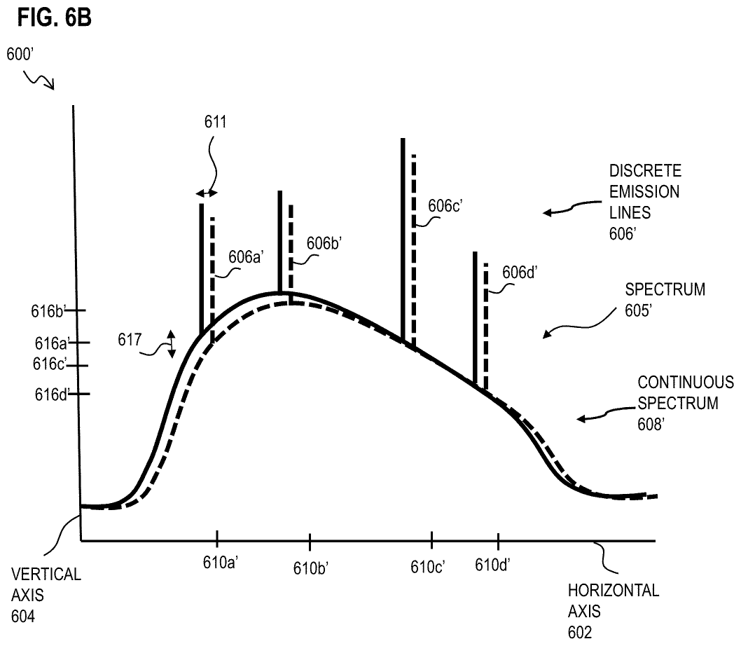

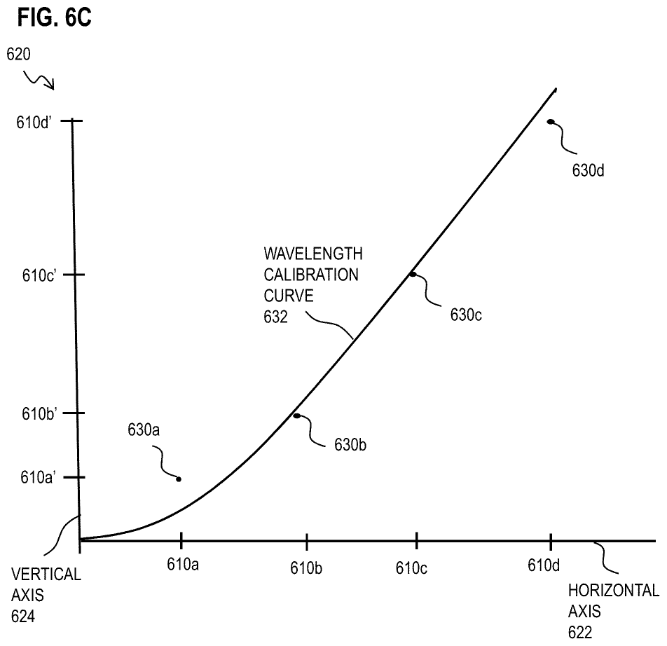

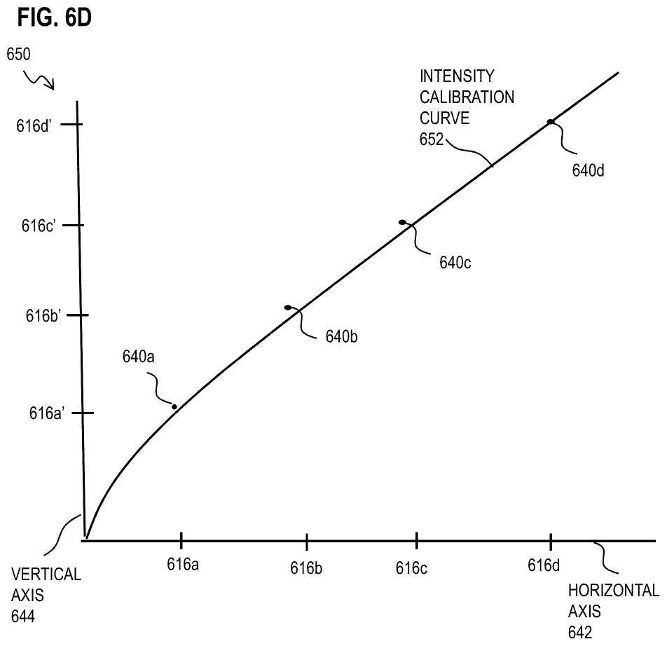

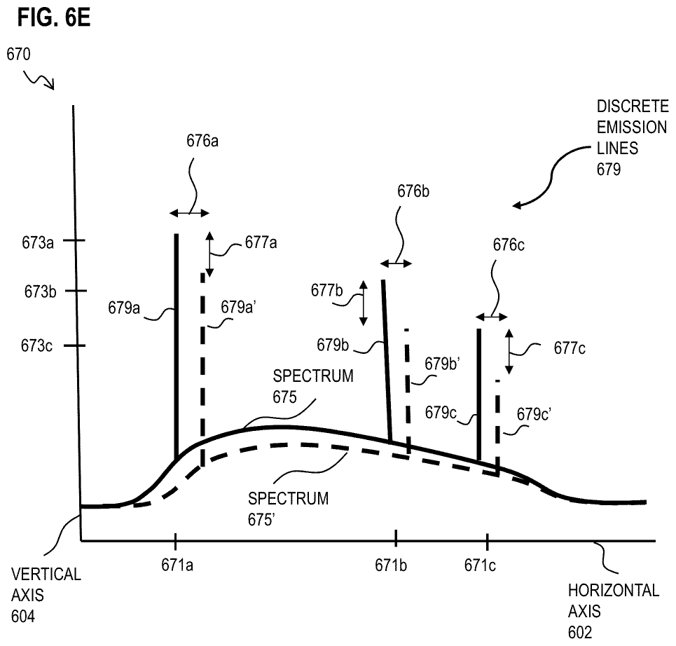

FIG. 6A is a graph that illustrates an example expected emission spectrum 605 of the optical calibration source 202 of FIG. 1B, according to an embodiment. The horizontal axis 602 is wavelength in arbitrary units. The vertical axis 604 is intensity in arbitrary units. In an embodiment, the one or more parameters of the optical source 202 are selected in order that the optical source 202 achieves the expected emission spectrum 605. In an embodiment, the expected emission spectrum 605 includes a continuous spectrum 608 over a wavelength range or spectral region 614 that corresponds to a wavelength range or spectral region of the spectrum of the target optical signal 116 emitted from the sample 104 of interest in the system 100. Additionally, the expected emission spectrum 605 includes discrete emission lines 606 superimposed on the continuous spectrum 608, where the discrete emission lines 606 are based on one or more elements within the gas 207. In one example embodiment, the expected emission spectrum 605 is achieved when a sufficient potential difference is established between the electrodes 608a, 608b. In an example embodiment, a minimum threshold number (e.g. from about 2 to about 5) of discrete emission lines 606 are in the wavelength range 614 corresponding to the wavelength range of the spectrum of the target optical signal 116 emitted from the sample 104 of interest. In another example embodiment, a maximum spacing is between adjacent emission lines 606 in the wavelength range 614 corresponding to the wavelength range of the spectrum of the target optical signal 116 emitted from the sample 104 of interest. In an example embodiment, a quantity and/or a spacing of the emission lines 606 is dependent on a resolution of a grating in the spectrophotometer (e.g. detector 108). In this example embodiment, as long as the emission lines 606 can be resolved (e.g. not overlapping) they can be used in the calibration. In one example embodiment, the more emission lines 606, the better (e.g. a minimum of 3) and in some embodiments, the number of emission lines 606 depends on the spectral region of interest over which the sample will be analyzed.

In an embodiment, a detector 210 is positioned in the housing 203 and adjacent the envelope 206. In one embodiment, the detector 210 is configured to sense an initial transmission of radiation from the ionized gas 207 from the envelope 206. In this embodiment, the detector 210 is connected to the processor 110 and transmits a signal to the processor 110 upon sensing the initial radiation of the gas 207 from the envelope 206. In an example embodiment, the processor 110 transmits a signal to the power supply 103 which in turn transmits signals to the connectors 209a, 209b, 209c to fire the envelope 206 (e.g. to emit a pulse or flash from the tube) and simultaneously transmits a signal to the detector 108 to open the detector 108 (e.g. spectrophotometer) to collect the spectrum of the collected optical signal 118′. In an embodiment, the detector 108 remains open until the flash from the envelope 206 ends or dies. In an example embodiment, the detector 210 is used to sense when the flash from the envelope 206 ends or dies and transmits a signal to the processor 110 to indicate that the flash from the envelope 206 has stopped. The processor 110 subsequently transmits a signal to the detector 108 or causes the power source 103 to transmit a signal to the detector 108 to close the detector 108 window. In an example embodiment, the duration of the flash from the envelope 206 and/or duration of that the detector 108 windows remains open to collect the spectrum of the optical signal 118′ is in a range from about 10 μs to about 100 μs. This advantageously enhances the signal to noise ratio (SNR) of the detector 108 since the detector 108 window does not remain open longer than necessary to detect the optical signal 118′ based on the flash from the envelope 206.

FIG. 2A depicts that the electronics (e.g. processor 110 and power supply 103) is separated from the optical source 202 with a cable 212 that includes a plurality of connections. In some embodiments, the processor 110 and power supply 103 are integrated into one component. In an embodiment, the cable 212 includes a pair of connections between the power supply 103 and the first and second connectors 209a, 209b so that the power supply 103 can apply a potential difference across the first and second electrodes 208a, 208b. In another embodiment, the cable 212 includes a connection between the power supply 103 and the third connector 209c so the power supply 103 can apply a trigger voltage to the third electrode 208c. In another embodiment, the cable 212 includes a connection between the processor 110 and the detector 210 so the processor 110 can receive the signal from the detector 210 indicating that the flash or pulse from the gas 207 of the envelope 206 has ceased, so that the processor 110 can then signal the detector 108 and/or cause the power supply 103 to signal the detector 108 to close a detection window of the optical signal 118′. By separating the electronics (e.g. processor 110, power supply 103) from the optical source 202, the optical source 202 is advantageously much smaller than calibration optical sources which are integral with a power source and controller/processor. This permits the optical source 202 to fit the form factor 204 that is based on the point of detection 112 so that the optical signal 116′ emitted by the optical source 202 emulates the target optical signal 116 emitted by the sample 104 of interest in the system 100, for optimal spectral and intensity calibration of the system 100.

FIG. 2B is a block diagram that illustrates a top view of one end of the envelope 206 of the optical calibration source 202 of FIG. 2A, according to an embodiment. FIG. 2C is a block diagram that illustrates a cross-sectional view taken along line 2C-2C in FIG. 2B, according to an embodiment. As previously discussed, it is desired that one or more characteristics of the optical signal 116′ (e.g. width, shape, intensity, etc.) emitted by the optical source 202 corresponds with one or more characteristics of the target optical signal 116 emitted by the sample 104 of interest in the system 100. In some embodiments, a portion of the surface area of the envelope 206 is covered with a material that is opaque over a wavelength range of the optical signal 116′ so that the optical signal 116′ is not emitted from all portions of the surface area of the envelope 206 in order that the emitted optical signal 116′ characteristics correspond with the optical signal 116 characteristics, such as the point of detection 112. Thus, in one embodiment, a cover 214 (e.g. made of a material that is opaque over the optical signal 116′ spectrum or emission spectrum of the gas 207) covers a first portion of the surface area of the envelope 206 and does not cover a second portion of the surface area of the envelope 206 through which the optical signal 116′ is emitted.

In this embodiment, the second portion is an opening 216 provided in the cover 214 that is sized such that a waveguide 218 couples the optical signal 116′ out of the opening 216. In other embodiments, a dimension (e.g. diameter) of the opening 216 is sized based on a corresponding dimension (e.g. width) of the optical signal 116 emitted from the sample 104. In this example embodiment, the waveguide 218 couples the optical signal 116′ from the opening 216 to the collection optics 106. In other embodiments, no waveguide 218 is provided and the emitted optical signal 116′ from the opening 216 is transmitted to the collection optics 106. In still other embodiments, more than one waveguide 218 couples an optical signal116′ out of the opening 216 to more than one system 100′ (e.g. more than one collection optics 106 and detector 108) to simultaneously calibrate more than one system 100′. In some embodiments, one or more optical couplers can be positioned within the envelope 206 adjacent the opening 216 to guide the optical signal 116′ out of the opening 216. In some embodiments, the form factor 204 is based on a collection efficiency of the optical signal 116′ from the opening 216 and thus the form factor 204 can be reduced based on enhanced collection efficiency of the optical signal 116′ out of the opening 216 (e.g. reduced number of waveguides 218, collection optic adjacent the opening 216, etc.). In other embodiments, the number and/or size of electrical components (e.g. electrodes 208, connectors 209) within the housing 203 can be reduced based on enhanced collection efficiency of the optical signal 116′ at the opening 216.

FIG. 8A is a flow chart that illustrates an example method 800 for fabricating the optical source 202 for calibrating the optical system 100, according to an embodiment. Although steps are depicted in FIG. 8A and in FIG. 8B, and in subsequent flowcharts as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 801, the form factor 204 for the optical source 202 is determined. In an embodiment, in step 801 the form factor 204 is determined based on the point of detection 112 of the optical system 100. In some embodiments, the form factor 204 is determined so that the optical signal 116′ of the optical source 202 has one or more characteristics (e.g. width, shape, intensity, spectrum, etc.) that correspond to one or more corresponding characteristics of the optical signal 116 radiated by the sample 104 from the point of detection 112. In some embodiments, the form factor 204 has one or more dimensions that are about equal to one or more dimensions of the point of detection 112 (e.g. where the point of detection 112 includes the sample 104). In other embodiments, the form factor 204 has dimensions that exceed the dimensions of the point of detection 112 (e.g. where the point of detection 112 only includes those portions of the sample 104 interacting with the beam 114).

In step 802, one or more parameter values of the optical source 202 is determined in order to achieve an expected emission spectrum. In an embodiment, the expected emission spectrum is based on an emission spectrum of the optical signal 116 radiated by the sample 104 interacting with the beam 114 in the system 100. In one embodiment, in step 802 the emission spectrum of the optical signal 116 radiated by the sample 104 of the system 100 is determined. In these embodiments, the emission spectrum of the optical signal 116 encompasses the emission spectrum of the optical signals 116 radiated by all samples 104 that are contemplated to be used in the system 100. In some embodiments, the expected spectrum is stored in the memory of the processor 110 and/or is provided to a user in the form of electronic or written information (e.g. communicating to the user what the expected intensity is for each wavelength).

In step 802, after determining the expected emission spectrum of the optical source 202, one or more characteristics of the optical source 202 is determined that affects the emission spectrum of the optical source 202. In an embodiment, these characteristics include one or more of the form factor 204; type of gas 207 placed in the envelope 206; the dimensions of the envelope 206 (e.g. exterior and interior dimensions); the material of the envelope 206; the electronics and connections used (e.g. the electrodes 208, connectors 209 and connections therebetween including connections with the power supply 103); and a value of the power signals applied to the electronics (e.g. potential difference applied from the power supply 103 across the electrodes 208a, 208b; trigger voltage value applied to the electrode 208c). In some embodiments, in step 802 the characteristics of the optical source 202 are theoretically derived in order that the optical source 202 emits the expected emission spectrum. In other embodiments, in step 802 the characteristics of the optical source 202 are empirically derived (e.g. cross checking with a known source or certified with National Institute of Standards and Technology or NIST) in order that the optical source 202 emits the expected emission spectrum.

In step 803, the envelope 206 is formed with a size and shape to fit the form factor 204. In one embodiment, the envelope 206 is formed based on the characteristics of the envelope 206 determined in step 802 in order that the optical source 202 will emit the expected emission spectrum. In an embodiment, the size and shape of the envelope 206 determined in step 802 is selected within a range so that the envelope 206 will fit within the form factor 204. As previously discussed, the envelope 206 is formed from a material that is transmissive over the expected emission spectrum of the optical source 202.

In step 803, one or more electrodes 208 are built with connectors 209 positioned outside the envelope 206. In an embodiment, the electrodes include the first and second electrodes 208a, 208b that are respectively positioned within the interior of the envelope 206. In one embodiment, the first and second electrodes 208a, 208b are respectively positioned within the interior of the envelope 206 adjacent a first and second end of the envelope 206. In an embodiment, a pair of connectors 209a, 209b are respectively connected to the first and second electrodes 208a, 208b are positioned external to the envelope 206 so that they are configured for connection to an external power source, e.g. power supply 103. In one embodiment, the first and second connectors 209a, 209b are positioned external to the envelope 206 adjacent the first and second ends of the envelope 206.

In some embodiments, in step 803 a third electrode 208c is positioned along an exterior surface of the envelope 206 between the first and second ends of the envelope 206. In one embodiment, a third connector 209c is connected to the third electrode 208c and the third connector 209c is configured for connection to an external power source, e.g. power supply 103. Although FIG. 2A depicts the third electrode 208c positioned along an exterior surface of the envelope 206 between the first and second ends of the envelope 206, in other embodiments the third electrode 208c is positioned along an interior surface of the envelope 206 between the first and second ends of the envelope 206.

In step 805, the envelope 206 formed in step 803 is filled with the gas 207. In an embodiment, the gas 207 is selected in step 802 so that the emission spectrum of the optical source 202 corresponds with the expected emission spectrum. In one embodiment, the emission spectrum of the gas 207 is considered in deciding which gas 207 to fill the envelope 206 in step 805 (e.g. along with the other parameters in step 802 that affect the emission spectrum of the optical source 202). In an embodiment, in step 805 the envelope 206 is filled with the gas 207 to a desired pressure (e.g. about 450 torrs or in a range from about 400 torr to about 500 torrs). In an embodiment, the envelope 206 is filled with the gas 207 with a pressure that is not too low so that the continuous spectrum 608 is maintained and is not too high so that the discrete emission lines 608 don't over-broaden Upon filling the envelope 206 with the gas 207, the envelope 206 is sealed using any method appreciated by one of ordinary skill in the art.

In step 807, a first portion of the envelope 206 is covered with a material to block radiation emitted by the gas 207 so that the radiation is emitted from a second portion of the envelope 206 other than the first portion. In an embodiment, the material is the cover 214 and the first portion of the envelope 206 covers with exterior surface of the envelope 206 with the exception of the opening 216 that is the second portion of the envelope 206 through which the optical signal 116′ is emitted from the envelope 206.

In step 809, a detector is provided adjacent the envelope 206 in the form factor 204. In an embodiment, the detector 210 detects an initial emission of radiation or a flash (e.g. optical signal 116′) emitted by the gas 207. In one embodiment, the detector 210 is configured for connection to an external power source (e.g. to the power supply 103 and/or the processor 110 with the cable 212). In some embodiments, upon detecting that the radiation or flash from the gas 207 in the tube 206 has ended, the detector 210 transmits a signal to the processor 110, which subsequently transmits a signal to the detector 108 to stop detecting the optical signal 118′ (e.g. close the detection window of the detector 108), to enhance the signal to noise ratio (SNR) of the detector 108. Although FIG. 2A depicts that the power supply 103 is external to the optical source 202, in some embodiments, the optical source 202 includes an internal power source that is connected to the electrodes within the housing 203 and the form factor 204. In an example embodiment, such an optical source with an internal power source can be provided for certain emission spectrum (e.g. wavelength above UV, etc.)

FIG. 8B is a flow chart that illustrates an example method 850 for using an optical source to calibrate the optical system 100, according to an embodiment. In step 851, the optical source 202 is positioned at a region corresponding to the point of detection 112 of the optical system 100. In an embodiment, in step 851, the sample 104 (if present) is removed from the point of detection 112. The optical source 202 is then positioned at the region corresponding to the point of detection 112. In one embodiment, in step 851 the optical source 202 is positioned at the region corresponding to the point of detection 112 so that the optical signal 116′ emitted from the optical source 202 overlaps or substantially overlaps with the optical signal 116 previously emitted from the sample 104 when the sample 104 was positioned at the point of detection 112. In another embodiment, in step 851 the optical source 202 is positioned at the region corresponding to the point of detection 112 so that the envelope 206 (e.g. opening 216) coincides with the sample 104 and/or portion of the sample 104 interacting with the beam 114 and/or portion of the sample 104 radiating the optical signal 116 during operation of the optical system 100. In yet other embodiments, the optical source 202 is positioned at the region corresponding to the point of detection 112, where the form factor 204 encloses the region corresponding to the point of detection 112. In this example embodiment, the point of detection 112 only includes that portion of the sample 104 that interacts with the beam 114 and/or the form factor 204 includes the housing 203 and multiple electronic components (e.g. electrodes, detector) within the housing 203.

In step 853, a signal is transmitted from the processor 110 and/or power supply 103 to the electrodes 208 of the optical source 202 to cause the gas 207 to emit radiation with an expected spectrum. In some embodiments, the processor 110 includes an internal power supply and the processor 110 transmits the signal to the electrodes 208. In an embodiment, in step 853 a cable 212 is provided between a power source (e.g. power supply 103 and/or processor 110) and electrical components (e.g. connectors 209, detector 210, etc.). In an embodiment, the cable 212 is a plurality of wires bound together, where each wire is for a respective connection between the power supply 103 and a respective electrical component. The cable 212 advantageously permits the power source to be separated from the optical source 202, thereby permitting the optical source 202 to have a reduced form factor 204 for purposes of placement at the region corresponding to the point of detection 112. In an embodiment, in step 853, the power supply 103 transmits one or more signals over the cable 212 to connectors 209 of the electrodes 208. In one embodiment, the power supply 103 transmits a first signal to the connectors 209a, 209b of the electrodes 208a, 208b to establish a potential difference in the gas 207 between the first and second ends of the envelope 206. In another embodiment, the power supply 103 transmits a second signal to the connector 209c of the third electrode 208c to establish the trigger voltage along the exterior of the envelope 206 between the first and second ends of the envelope 206 to initiate radiation of the ionized gas 207.

In an embodiment, based on the signals transmitted to the electrodes 208, the gas 207 emits the optical signal 116′ with the expected spectrum 605 of FIG. 6A including the continuous spectrum 608 with a predetermined or expected intensity and the discrete emission lines 606 at a plurality of predetermined or expected wavelengths. In one embodiment, as depicted in FIG. 6A the continuous spectrum 608 has a predetermined or expected intensity 616a, 616b, 616c, 616d and the discrete emission lines 606 occur at predetermined or expected wavelength values 610a, 610b, 610c, 610d. As previously discussed, the expected spectrum 605 of the optical source 202 is theoretically or empirically determined (e.g. cross checked with a known source) during the fabrication method 800. In one embodiment, in step 853 the optical signal 116′ is coupled into the waveguide 218 through the opening 216 in the cover 214 along the exterior of the envelope 206 and the waveguide 218 directs the optical signal 116′ to the collection optics 106. In another embodiment, in step 853 the optical signal 116′ is transmitted out of the envelope 206 that is positioned in the point of detection 112 so that the emitted optical signal 116′ from the envelope 206 has one or more characteristics corresponding to the emitted optical signal 116 from the sample 104 in the system 100.

In step 855, an intensity of the continuous spectrum 608 of the emission spectrum 605 transmitted in step 853 is measured. In another embodiment, in step 855, wavelength values of the discrete emission lines 606 of the emission spectrum 605 transmitted in step 853 are measured. In some embodiments, the processor 110 initiates a delay between steps 853 and 855 so that the optical source 202 can emit radiation for a predetermined time or number of pulses, so that the optical source 202 can reach thermal equilibrium. In one embodiment, in step 855 the intensity of the continuous spectrum 608 and the wavelength values of the discrete emission lines 606 is measured by the detector 108 of the optical system 100. In one embodiment, a signal is transmitted from the detector 108 to the processor 110 with data indicating the measured intensity data and measured wavelength value data. In another embodiment, in step 855 the intensity of the continuous spectrum 608 and the wavelength values of the discrete emission lines is measured over the wavelength range or spectral region 614 of the emission spectrum 605. FIG. 6B is a graph 600′ that illustrates an example detected spectrum 605′ of the optical calibration source 202 of FIG. 1B, according to an embodiment. In an embodiment, the detected spectrum 605′ includes a detected continuous spectrum 608′ and detected discrete emission lines 606′. It should be noted that the detected spectrum 605′, detected continuous spectrum 608′ and detected discrete emission lines 606′ are dotted in FIG. 6B and shown along with the expected spectrum (solid line). Unlike the expected spectrum 605 of FIG. 6A, where the discrete emission lines 606a, 606b, 606c, 606d are at respective wavelength values 610a, 610b, 610c, 610d, the detected spectrum 605′ includes detected discrete emission lines 606a′, 606b′, 606c′, 606d′ with shifted wavelength values 610a′, 610b′, 610c′, 610d′. In an embodiment, a wavelength shift 611 is depicted between the discrete emission line 606a of the expected spectrum 605 and the discrete emission line 606a′ of the detected spectrum 605′. Although FIG. 6B depicts four emission lines 606, 606′, the embodiments of the present invention is not limited to an emission spectrum with any particular number of emission lines.

In another embodiment, unlike the expected spectrum 605 of FIG. 6A, with the intensity 616a, 616b, 616c, 616d of the continuous spectrum 608 at respective wavelength values 610a, 610b, 610c, 610d of the discrete emission lines 606, the detected spectrum 605′ includes shifted intensity s 616a′, 616b′, 616c′, 616d of the detected continuous spectrum 608′ at respective wavelength values 610a′ 610b′, 610c′, 610d′ of the discrete emission line 606′. In an embodiment, an intensity shift 617 is depicted between the expected continuous spectrum 608 and the detected continuous spectrum 608′ for the wavelength value corresponding to the first emission line. Although FIG. 6B depicts that the intensity shift 617 between the expected continuous spectrum 608 and detected continuous spectrum 608′ was measured at the wavelength values corresponding to the discrete emission lines, the embodiments of the invention is not limited to assessing the intensity shift 617 at these particular wavelength values and the intensity shift 617 of the continuous spectrum 608, 608′ can instead be measured at any wavelength value along the wavelength range or spectral region 614 (e.g. based on resolution width of the detector 108).

In step 857, an intensity calibration curve is determined by the processor 110 based on the detection data measured in step 855 by the detector 108 and transmitted to the processor 110. In another embodiment, the intensity calibration curve is determined over the wavelength range or spectral region 614 based on a closest fit of the detected intensity 616a′, 616b′, 616c′, 616d′ and the expected intensity 616a, 616b, 616c, 616d. FIG. 6D is a graph 650 that illustrates an example intensity calibration curve 652 of the optical system 100 of FIG. 1A, according to an embodiment. The horizontal axis 642 is the expected intensity in arbitrary units. The vertical axis 642 is the detected intensity in arbitrary units. A first data point 640a indicates the expected intensity 616a and detected intensity 616a′ of the continuous spectrum 608, 608′ at the wavelength value corresponding to the first discrete emission line. A second data point 640b indicates the expected intensity 616b and detected intensity 616b′ of the continuous spectrum 608, 608′ at the wavelength value corresponding to the second discrete emission line. A third data point 640c indicates the expected intensity 616c and detected intensity 616c′ of the continuous spectrum 608, 608′ at the wavelength value corresponding to the third discrete emission line. A fourth data point 640d indicates the expected intensity 616d and detected intensity 616d′ of the continuous spectrum 608, 608′ at the wavelength value corresponding to the fourth discrete emission line. In an embodiment, the processor 110 determines the intensity calibration curve 652 using the data points 640a, 640b, 640c, 640d and a closest fit algorithm known by one of skill in the art (e.g. a lower order polynomial, least squares, etc.).

In step 859, a wavelength calibration curve is determined by the processor 110 based on the detection data measured in step 855 by the detector 108 and transmitted to the processor 110. In another embodiment, the wavelength calibration curve is determined over the wavelength range or spectral region 614 based on a closest fit of the detected wavelength values 610a′, 610b′, 610c′, 610d′ and the expected wavelength values 610a, 610b, 610c, 610d corresponding to the discrete emission lines. FIG. 6C is a graph that illustrates an example wavelength calibration curve 632 of the optical system 100 of FIG. 1A, according to an embodiment. The horizontal axis 622 is the expected wavelength value in arbitrary units. The vertical axis 624 is the detected wavelength value in arbitrary units. A first data point 630a indicates the expected wavelength value 610a and detected wavelength value 610a′ of the first discrete emission line. A second data point 630b indicates the expected wavelength value 610b and detected wavelength value 610b′ of the second discrete emission line. A third data point 630c indicates the expected wavelength value 610c and detected wavelength value 610c′ of the third discrete emission line. A fourth data point 630d indicates the expected wavelength value 610d and detected wavelength value 610d′ of the fourth discrete emission line. In an embodiment, the processor 110 determines the wavelength calibration curve 642 using the data points 630a, 630b, 630c, 630d and a closest fit algorithm known by one of skill in the art (e.g. a lower order polynomial, least squares, etc.). Although the wavelength calibration curve 632 and intensity calibration curves 652 are depicted to fit to four data points, in other embodiments of the invention the wavelength calibration curves and intensity calibration curves are fit to less or more than four data points.

In step 861, the intensity calibration curve 652 is stored in a memory of the processor 110. In another embodiment, in step 861, the wavelength calibration curve 632 is stored in a memory of the processor 110. In still other embodiments, in step 861 the intensity calibration curve 652 and the wavelength calibration curve 632 are stored in the memory of the processor 110.

In an embodiment, after the optical system 100 is calibrated and the intensity calibration curve 652 and/or wavelength calibration curve 632 are stored in the memory of the processor 110, the calibration curve(s) can be used to enhance the accuracy of the system 100 scanning the spectrum of an optical signal116 radiated by a sample 104. In one embodiment, after the calibration optical source 202 is removed from the system 100 after performing the method 850, a sample 104 is positioned in the point of detection 112. In this embodiment, the optical source 102 transmits the optical beam 114 at the sample 104 which causes the sample to interact with the beam 114 and radiate the optical signal 116. In one embodiment, the detector 108 measures an emission spectrum 675′ of the collected optical signal 118 from the collection optics 106. FIG. 6E is a graph that illustrates an example detected and corrected spectrum of a material using the calibrated optical system of FIG. 1A, according to an embodiment. The horizontal axis 602 is wavelength in arbitrary units. The vertical axis 604 is intensity in arbitrary units. In an embodiment, the detected spectrum 675′ includes a plurality of discrete emission lines 679a′, 679b′, 679c′ with respective intensity and wavelength values.

In an embodiment, the processor 110 corrects the detected spectrum 675′ by correcting the wavelength values of the detected discrete emission lines 679a′, 679b′, 679c′ using the wavelength calibration curve 632. In one embodiment, the processor 110 determines corrected wavelength values 671a, 671b, 671c for the discrete emission lines based on those wavelength values along the horizontal axis 622 that correspond to the detected wavelength values of the discrete emission lines in the detected spectrum 675′ along the vertical axis 624. In one embodiment, FIG. 6E depicts that the detected wavelength values of the detected emission lines 679a′, 679b′, 679c′ are respectively shifted by amounts 676a, 676b, 676c to obtain the corrected wavelength values 671a, 671b, 671c of the corrected emission lines 679a, 679b, 679c.

In an embodiment, the processor 110 corrects the detected spectrum 675′ by correcting the intensity values of the detected discrete emission lines 679a′, 679b′, 679c′ using the intensity calibration curve 652. In one embodiment, the processor 110 determines corrected intensity values 673a, 673b, 673c for the discrete emission lines based on those intensity values along the horizontal axis 642 that correspond to the detected intensity values of the discrete emission lines in the detected spectrum 675′ along the vertical axis 644. In one embodiment, FIG. 6E depicts that the detected intensity values of the detected emission lines 679a′, 679b′, 679c′ are respectively shifted by amounts 677a, 677b, 677c to obtain the corrected intensity values 673a, 673b, 673c of the corrected emission lines 679a, 679b, 679c.

In an embodiment, the corrected spectrum 675 is used in the optical system 100 rather than the detected spectrum 675′ and provides numerous advantages including more accurate measurement of the spectrum of the optical signal radiated by a sample 104 and thus more accurate calculation of ratios of intensity of discrete emission lines of the measured spectrum. In an example embodiment, this enhances the accuracy of the measurements in the chemical calibration module 120. Additionally, this enhances the accuracy of the measurement of the spectrum of a sample with an unknown ratio of elements (e.g. identification module 122).

### 2. Example Embodiments of Optical Source

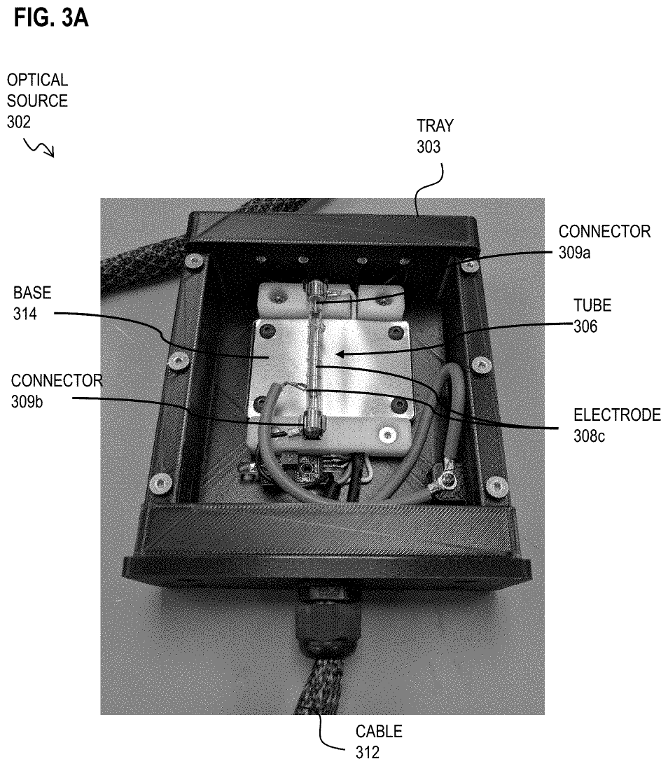

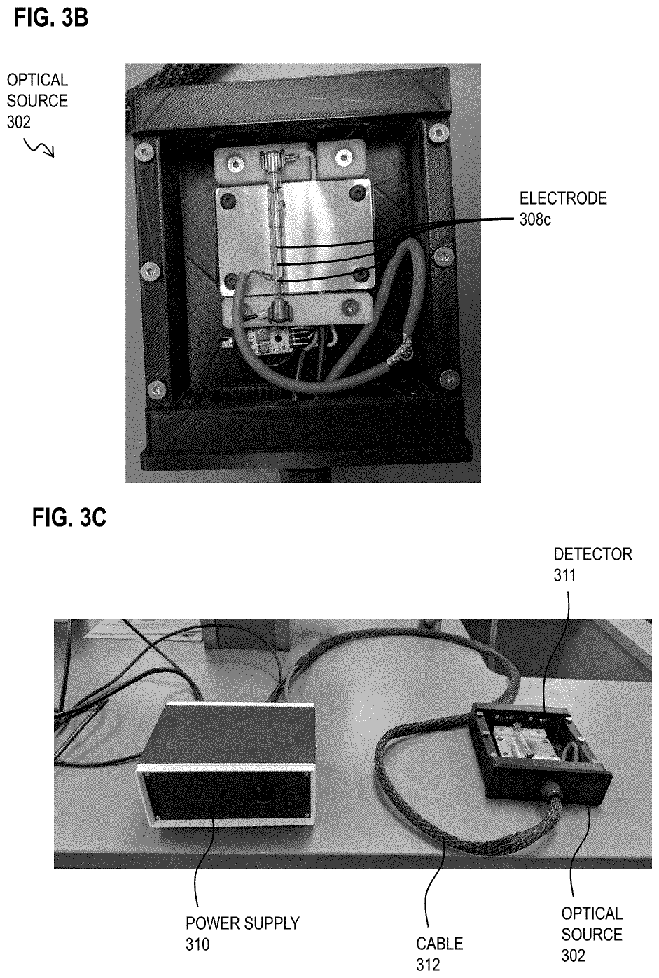

FIGS. 3A-3C are images that illustrate top perspective views of example components of an optical calibration source of the system 100 FIG. 1B, according to an embodiment. In an embodiment, the optical source 302 includes a housing or tray 303 with an opening to receive the components of the optical source 302. In one example embodiment, the tray 303 is 3D-printed with Acrylonitrile butadiene styrene (ABS), Nylon, Delrin or Polyethylene terephthalate (PET) material. In an example embodiment, one or more dimensions of the tray 303 (e.g. length, width, height, etc.) are sized so that the tray 303 fits the form factor 204. In some embodiments, the dimensions of the tray 303 are sized so that the tray 303 can slide into a slot provided in the system 100 adjacent the point of detection 112 (e.g. with an opening in the tray 303 facing the direction to direct the optical signal 116′ from the source 302 at the collection optics 106). In one embodiment, a base 314 is mounted within the tray 303 using one or more bolts or screws.

In an embodiment, the envelope of the optical source 302 is a tube 306 that is filled with the gas 207 and sealed. In one embodiment, the gas 207 is Xenon. In other embodiments, the gas 207 is one or more of Mercury (Hg), Krypton (Kr), Xenon (Xe) and Deuterium (D₂). In one example embodiment, the tube 306 is formed from fused silica and/or excludes cerium (e.g. so that the tube 306 is transmissive in the UV spectrum). In another example embodiment, the tube 306 is formed from a material so that the transmission spectrum of the tube 306 corresponds with the emission spectrum of the optical signal 116 from the sample 104 in the system 100 (e.g. from about 180 nm to about 2 μm and/or from about 100 nm to about 7 μm).

In an embodiment, the tube 306 is mounted to the base 314 in the tray 303. In an embodiment, the first and second ends of the tube 306 are secured to the first and second connectors 309a, 309b which are respectively connected to the first and second electrodes within the tube 306. The first and second connectors 309a, 309b are further connected to a power supply 310 through a pair of wires provided in the cable 312 that connects the electrical components within the tray 303 with the power supply 310. In some embodiments, the power supply 310 is similar to the processor 110 and power supply 103 in the embodiment of FIG. 2A. In an example embodiment, the first electrode connected to the first connector 309a is at a first potential (e.g. about 0 volts) and the second electrode connected to the second connector 309b is at a second potential (e.g. about 400 volts) when connected to the power supply 310. Thus, a polarized potential difference is applied across the first and second electrodes. In some embodiments, as depicted in FIG. 3C the cable 312 has sufficient length (e.g. from about 3 feet to about 10 feet) so that the electrical components of the optical source 302 can be separated from the power supply 310. This advantageously ensures that the dimensions of the optical source 302 fits the form factor 204 and thus that the optical source 302 can be placed at the point of detection 112 to calibrate the optical system 100.

In another embodiment, the third electrode 308c is depicted along the exterior of the tube 306 between the first and second ends of the tube 306. In an embodiment, the third electrode 308c takes a helical form that winds around the exterior of the tube 306 between the first and second ends of the tube 306. In some embodiments, the third electrode 308c is made from one or more of copper, stainless steel and/or nickel-plated copper. In an embodiment, the third connector of the third electrode 308c is connected to the power supply 310 with a third wire. In an example embodiment, a trigger voltage (e.g. 9 kilovolts or kV) is applied to the third electrode 308c from the power supply 310 to initiate the discharge of the ionized gas 207 and the radiation of the optical signal 116′ from the tube 306. In a further embodiment, a detector 311 is provided in the tray 303 and is similar to the detector 210.

In some embodiments, the optical source 302 is fabricated using one or more steps of the method 800. In an embodiment, in step 801 the form factor 204 of the optical source 302 is determined based on the point of detection 112 of the optical system 100, in a similar manner as previously discussed.

In an embodiment, in step 802 one or more parameter values of the optical source 302 are determined to achieve the expected emission spectrum. In one embodiment, the expected emission spectrum is the emission spectrum of Xenon chosen as the gas 207. In another embodiment, in step 802 fused silica is chosen as the material of the tube 306. In another example embodiment, one or more dimensions of the tube 306 are determined including a length in a range from about 15 millimeters (mm) to about 150 mm, and a width (e.g. outer diameter) in a range from about 5 mm to about 10 mm.

In an embodiment, in steps 803 and 805 the tube 306 is formed of fused silica with the dimensions determined in step 802. In another embodiment, the first and second electrodes are provided inside the tube 306 adjacent the first and second ends of the tube 306a with the first and second connectors 309a, 309b outside of the tube 306. In an embodiment, in step 805 the tube 306 is filled with Xenon gas and sealed. In an example embodiment, the tube 306 is formed, filled with gas 207 and sealed using any method appreciated by one of ordinary skill in the art. In one example embodiment, the tube 306 can be custom ordered from a manufacturer, such as Advanced Strobe Products®, Inc of Harwood Heights, Ill.

In an embodiment, in step 807 the cover 214 is provided over the exterior of the tube 306 so that light emitted by the gas 207 is only transmitted from the tube 306 through the opening 216. In an example embodiment, the cover 214 is made from pure silicia (e.g. if the spectral region 614 of FIG. 6A is to include ultraviolent or UV) or any material that is opaque at the emission spectrum of the gas 207.

In some embodiments, the optical source 302 is used to calibrate an optical system 100 using one or more steps of the method 850. In an embodiment, in step 851 the optical source 302 is positioned at the point of detection 112 of the optical system 100, in a similar manner as previously discussed.

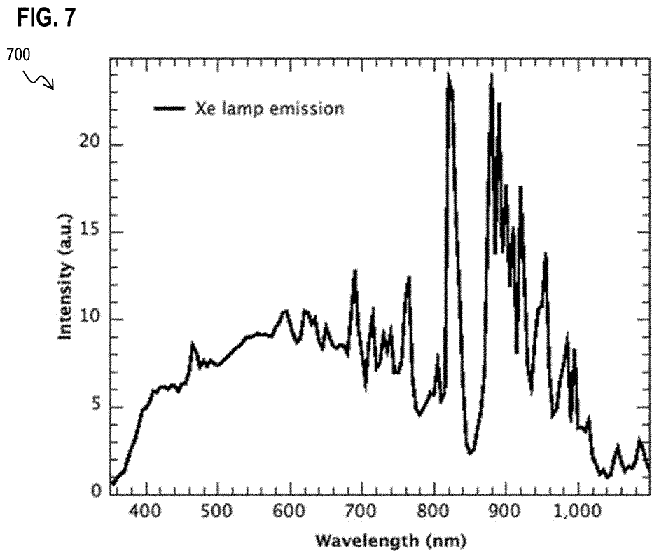

In an embodiment, in step 853 the processor 110 transmits a signal to the power supply 103 to transmit a signal to the electrodes (via the connectors) to cause the gas 207 to emit radiation with the emission spectrum 605. In some embodiments, the processor 110 includes an internal power supply and in step 853 the processor 110 transmits the signal to the electrodes. In one embodiment, in step 853 the gas 207 will emit radiation with the emission spectrum of Xenon. FIG. 7 is a graph that illustrates an example emission spectrum 700 of Xenon gas according to an embodiment. In an example embodiment, the power supply 103 transmits the signal to the electrodes for a duration time so that the tube 306 generates a pulse of radiation with a duration from about 100 μs to about 1000 μs and energy of about 6 Joules (J) or in a range from about 1 J to about 10 J. In another example embodiment, the tube 306 is configured to sustain more than 100,000 pulses or shots. In an embodiment, the remaining steps 855, 857, 859, 861 are performed in a similar manner as previously discussed.

### 3. Example Embodiments of Optical Systems

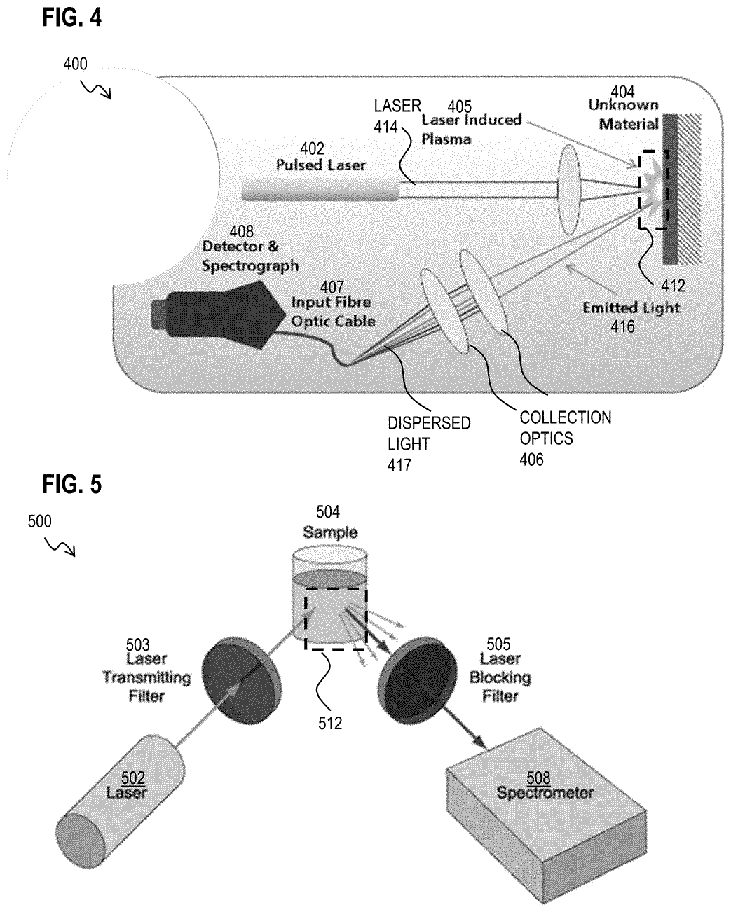

FIG. 4 is a schematic diagram that illustrates example components of a laser induced breakdown spectroscopy (LIBS) system 400, according to an embodiment. Laser-induced breakdown spectroscopy (LIBS) is a type of atomic emission spectroscopy system 100 which uses a laser source 402 as the optical source 102 that emits a highly energetic laser 414 as the beam 114 in the optical system 100. In an embodiment, the laser 414 is focused on a sample or unknown material 404 to form a laser induced plasma 405, which atomizes and excites samples.

In one embodiment, the formation of the plasma 405 begins when the focused laser achieves a certain threshold for optical breakdown, which generally depends on the environment and the unknown sample target material 404. In principle, the LIBS system 400 can analyze any sample regardless of its physical state, be it solid, liquid or gas. Since all elements emit light of characteristic wavelength when excited to sufficiently high temperatures, the LIBS system 400 can (in principle) detect all elements, limited only by the power of the laser 414 as well as the sensitivity and wavelength range or spectral region of the spectrograph & detector 408. If the constituents of the sample or unknown material 404 to be analyzed are known, the LIBS system 400 can be used to evaluate the relative abundance of each constituent element, or to monitor the presence of impurities. In practice, detection limits are a function of a) the plasma excitation temperature, b) the light collection window, and c) the line strength of the viewed transition. In one embodiment the LIBS system 400 makes use of optical emission spectrometry and is to this extent very similar to arc/spark emission spectroscopy.

In an embodiment, the LIBS system 400 operates by focusing the laser 414 onto a small area at the surface of the sample or unknown material 404. When the laser 414 is discharged it ablates a very small amount of the material 404 (e.g. in the range of nanograms to picograms) which generates a plasma plume with hot temperatures (e.g. in excess of 100,000 K). In some embodiments, a point of detection 412 of the LIBS system 400 encloses the unknown material 404 and/or is a region corresponding to the ablated portion of the material 404 and/or is a region corresponding to the plasma 405 and/or a portion of the unknown material 404 interacting with the laser 414. In an embodiment, during data collection by the detector 408, typically after local thermodynamic equilibrium is established, plasma temperatures are in a range from about 5,000 K to about 20,000 K. In an embodiment, at the high temperatures during the early plasma, the ablated material dissociates (e.g. breaks down) into excited ionic and atomic species. During this time, the plasma 405 emits a continuum of radiation which does not contain any useful information about the species present in the material 404, but within a very small timeframe the plasma 405 expands at supersonic velocities and cools. At this point the plasma 405 emits light 416 with a characteristic spectrum including atomic emission lines of the elements in the material 404. In an embodiment, the emitted light 416 is shaped by the collection optics 406 to form dispersed light 417 which is directed into a tip of an input optical fiber cable 407 and into the detector 408. In one embodiment, a delay between the emission of continuum radiation and characteristic radiation (e.g. on the order of 10 μs) is stored in a memory of the processor 110. In one embodiment, in step 855 the processor 110 delays sending a signal to the detector 108 based on the stored delay in the memory, to initiate the detection of the dispersed light 417 with the characteristic spectrum of the elements in the material 404.

In some embodiments, the LIBS system 400 includes the laser 414 (e.g. Nd:YAG solid-state laser) and a spectrometer (e.g. optics 406 and detector 408) with a wide spectral range and a high sensitivity, fast response rate, time gated detector. This is coupled to the processor 110 which can rapidly process and interpret the acquired data. In one embodiment, the laser 414 generates energy in the near infrared region of the electromagnetic spectrum (e.g. wavelength of 1064 nm) and a pulse duration (e.g. in the region of 10 ns) generating a power density which can exceed 1 GW·cm-2 at the focal point. In other embodiments, other lasers have been used, such as the Excimer (e.g. Excited dimer) type that generates energy in the visible and ultraviolet regions.

In an embodiment, the spectrometer is either a monochromator (scanning) or a polychromator (non-scanning) and a photomultiplier or CCD detector respectively. In an example embodiment, the spectrometer is a Czerny-Turner type monochromator. In another example embodiment, the spectrometer is an Echelle type polychromator. In an embodiment, the spectrometer collects electromagnetic radiation over the widest wavelength range possible, maximizing the number of emission lines detected for each particular element. In one example embodiment, a spectrometer response is typically from about 1100 nm (near infrared) to about 170 nm (deep ultraviolet), the approximate response range of a CCD detector.

In an embodiment, an optical source 202 can be fabricated to calibrate the LIBS system 400 using the method 800. In step 801, the form factor 204 of the optical source 202 is determined based on the point of detection 412 of the LIBS system 400. In an embodiment, in step 802 the expected emission spectrum is determined based on the emission spectrum of the emitted light 416 of the various unknown material 404 used in the LIBS system 400. In another embodiment, in step 802 the expected emission spectrum is also based on an intensity of the emission spectrum of the emitted light 416 of the various unknown material 404 used in the LIBS 404 system. The remaining steps of the method 800 are performed as previously discussed.

In an embodiment, the optical source 202 fabricated with the method 800 can be used to calibrate the LIBS system 400 using the method 850. In step 851, the optical source 202 is positioned at the point of detection 412 of the LIBS system 400 (e.g. region corresponding to the plasma 405 and/or a region corresponding to a portion of the material 404 interacting with the laser 414). In some embodiments, the optical source 202 is positioned at the point of detection 412 so that the optical signal 116′ emitted from the optical source 202 has one or more similar characteristics (e.g. shape, width, intensity, etc.) as the emitted light 416 from the plasma 405. In an embodiment, the remaining steps of the method 850 are performed as previously discussed.

In an embodiment, the calibrated LIBS system 400 has several advantages. In one embodiment, the processor 110 uses the intensity calibration curve 652 to correct a detected intensity of a spectrum from emitted light 416 from a plasma 405. In one embodiment, the processor 1110 then uses the corrected intensity of the spectrum of the emitted light 416 to determine a plasma temperature of the plasma 405. In an example embodiment, any method is used to retrieve the plasma temperature with the corrected intensity (e.g. Saha's equation and/or Boltzmann plot), as appreciated by one skilled in the art. ].

In another embodiment, the calibrated LIBS system 400 can be used to normalize the detected spectrum of the plasma 405 according to plasma temperature. In this embodiment, two detected spectrums from two different plasmas with different temperature (e.g. 9000K, 10000K) and the same elements can be meaningfully compared. Upon detecting the two spectrums by the detector 408 the processor 110 performs the instructions of the calibration module 114 to correct the two spectrums based on spectrum and intensity.

In an embodiment, the LIBS system 400 is technically similar to a number of other laser-based analytical techniques, sharing much of the same hardware. These techniques are the vibrational spectroscopic technique of Raman spectroscopy, and the fluorescence spectroscopic technique of laser-induced fluorescence (LIF), all of which can be employed as the optical system 100.

FIG. 5 is a schematic diagram that illustrates example components of a Raman spectroscopy system 500, according to an embodiment. In an embodiment, the Raman spectroscopy system 500 employs a spectroscopic technique to observe vibrational, rotational, and other low-frequency modes in a sample 504. Raman spectroscopy is commonly used in chemistry to provide a structural fingerprint by which molecules can be identified. It relies on inelastic scattering, or Raman scattering, of monochromatic light, usually from a laser 502 in the visible, near infrared, or near ultraviolet range. In an embodiment, the laser 502 interacts with molecular vibrations, phonons or other excitations in the sample 504, resulting in the energy of the laser 502 photons being shifted up or down. The shift in energy gives information about the vibrational modes in the sample 504. In one embodiment, the laser 502 is transmitted through a laser transmitting filter 503 and to a sample 504 which is illuminated. In an embodiment, electromagnetic radiation from the illuminated spot is sent through a laser blocking filter 505, collected with a lens and sent through a spectrometer 508 (e.g. monochromator). In an example embodiment, elastic scattered radiation at the wavelength corresponding to the laser line (e.g. Rayleigh scattering) is filtered out by a filter 505 (e.g. either a notch filter, edge pass filter, or a band pass filter) while the rest of the collected light is dispersed onto a detector (e.g. spectrometer 508).

In an embodiment, a point of detection 512 of the system 500 is based on a region corresponding to the sample 504 and/or a portion of the sample 504 interacting with the laser 502. In an embodiment, an optical source 202 can be fabricated to calibrate the Raman spectroscopy system 500 using the method 800. In step 801, the form factor 204 of the optical source 202 is determined based on the point of detection 512 of the Raman Spectroscopy system 500. In an embodiment, in step 802 the expected emission spectrum is determined based on the emission spectrum of the emitted light of the various samples 504 used in the Raman spectroscopy system 500. The remaining steps of the method 800 are performed as previously discussed.

### 4. Computational Hardware Overview

FIG. 9 is a block diagram that illustrates a computer system 900 upon which an embodiment of the invention may be implemented. Computer system 900 includes a communication mechanism such as a bus 910 for passing information between other internal and external components of the computer system 900. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). ). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of one or more methods described herein.

A sequence of binary digits constitutes digital data that is used to represent a number or code for a character. A bus 910 includes many parallel conductors of information so that information is transferred quickly among devices coupled to the bus 910. One or more processors 902 for processing information are coupled with the bus 910. A processor 902 performs a set of operations on information. The set of operations include bringing information in from the bus 910 and placing information on the bus 910. The set of operations also typically include comparing two or more units of information, shifting positions of units of information, and combining two or more units of information, such as by addition or multiplication. A sequence of operations to be executed by the processor 902 constitutes computer instructions.

Computer system 900 also includes a memory 904 coupled to bus 910. The memory 904, such as a random access memory (RAM) or other dynamic storage device, stores information including computer instructions. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of computer instructions. The computer system 900 also includes a read only memory (ROM) 906 or other static storage device coupled to the bus 910 for storing static information, including instructions, that is not changed by the computer system 900. Also coupled to bus 910 is a non-volatile (persistent) storage device 908, such as a magnetic disk or optical disk, for storing information, including instructions, that persists even when the computer system 900 is turned off or otherwise loses power.

Information, including instructions, is provided to the bus 910 for use by the processor from an external input device 912, such as a keyboard containing alphanumeric keys operated by a human user, or a sensor. A sensor detects conditions in its vicinity and transforms those detections into signals compatible with the signals used to represent information in computer system 900. Other external devices coupled to bus 910, used primarily for interacting with humans, include a display device 914, such as a cathode ray tube (CRT) or a liquid crystal display (LCD), for presenting images, and a pointing device 916, such as a mouse or a trackball or cursor direction keys, for controlling a position of a small cursor image presented on the display 914 and issuing commands associated with graphical elements presented on the display 914.

In the illustrated embodiment, special purpose hardware, such as an application specific integrated circuit (IC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 970 sends and receives electrical, acoustic or electromagnetic signals, including infrared and optical signals, that carry information streams, such as digital data.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 902, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 902, except for carrier waves and other signals.

Logic encoded in one or more tangible media includes one or both of processor instructions on a computer-readable storage media and special purpose hardware, such as ASIC *920.

Network link 978 typically provides information communication through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990. A computer called a server 992 connected to the Internet provides a service in response to information received over the Internet. For example, server 992 provides information representing video data for presentation at display 914.

The invention is related to the use of computer system 900 for implementing the techniques described herein. According to one embodiment of the invention, those techniques are performed by computer system 900 in response to processor 902 executing one or more sequences of one or more instructions contained in memory 904. Such instructions, also called software and program code, may be read into memory 904 from another computer-readable medium such as storage device 908. Execution of the sequences of instructions contained in memory 904 causes processor 902 to perform the method steps described herein. In alternative embodiments, hardware, such as application specific integrated circuit 920, may be used in place of or in combination with software to implement the invention. Thus, embodiments of the invention are not limited to any specific combination of hardware and software.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server 992 transmits program code for a particular application, requested by a message sent from computer 900, through Internet 990, ISP equipment 984, local network 980 and communications interface 970. The received code may be executed by processor 902 as it is received, or may be stored in storage device 908 or other non-volatile storage for later execution, or both. In this manner, computer system 900 may obtain application program code in the form of a signal on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red a carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to perform one or more steps of a method described herein and includes, for instance, the processor and memory components described with respect to FIG. *9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of a method described herein.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1005 also stores the data associated with or generated by the execution of one or more steps of the methods described herein.

### 5. Alternatives, Deviations and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A method for fabricating an optical source for calibrating an optical system, comprising:
determining a form factor for an optical source based on a point of detection of an optical system corresponding to a region where an optical signal of the optical system interacts with a sample;
providing an envelope in a size and shape to fit the form factor;
providing a plurality of electrodes connected to the envelope for connection to a power source; and
filling the envelope with a gas.

2. A method as recited in claim 1, wherein the optical system employs atomic emission spectroscopy and wherein the point of detection corresponds to a source of radiation emitted by the sample after interaction with the optical signal.

3. A method as recited in claim 2, wherein the optical system is a Raman spectroscopy system.

4. A method as recited in claim 2, wherein the optical system is a laser induced breakdown spectroscopy (LIBS) system and wherein the point of detection corresponds to an ablated portion of the sample.

5. A method as recited in claim 2, wherein the point of detection has a dimension not greater than about 10 cm.

6. A method as recited in claim 2, wherein the envelope is made from a material that is transparent over a bandwidth of the radiation emitted by the sample.

7. A method as recited in claim 1, wherein the envelope is a tube formed from fused silica.

8. A method as recited in claim 1, wherein the providing the envelope comprises forming the envelope, wherein the forming step comprises forming a housing with a size and a shape to fit the form factor and forming the envelope with the size and the shape to fit inside the housing.

9. A method as recited in claim 2, wherein the gas is selected such that an emission spectrum of the gas comprises a continuous spectrum and a plurality of discrete emission lines superimposed on the continuous spectrum over a spectral region of the radiation emitted by the sample from a first wavelength to a second wavelength.

10. A method as recited in claim 1, wherein the gas is Xenon.

11. A method as recited in claim 1, wherein the providing the plurality of electrodes includes providing a first electrode at a first end of the envelope and providing a second electrode at a second end of the envelope, wherein the first electrode and the second electrode are polarized with respect to each other.

12. A method as recited in claim 11, wherein the providing the plurality of electrodes further includes providing a third electrode along an exterior surface of the envelope between the first end and the second end.

13. A method as recited in claim 2, further comprising covering a first portion of the envelope with material to block transmission of radiation emitted by the gas such that the radiation emitted by the gas is configured to be emitted only from a second portion of the envelope other than the first portion of the envelope.

14. A method as recited in claim 1, further comprising providing a detector adjacent to envelope in the form factor, said detector is configured to detect radiation emitted by the gas from the envelope and wherein the detector is configured to be coupled to a processor.

15. A method for using the optical source of claim 1 to calibrate the optical system, comprising:
positioning the optical source at the point of detection of the optical system;
connecting, with a cable, a plurality of connectors of the respective the plurality of electrodes to a power supply;
transmitting, with the power supply, a signal to the plurality of electrodes to cause the gas to emit radiation through the envelope with an emission spectrum over a spectral region comprising a continuous spectrum with an expected intensity and a plurality of discrete emission lines superimposed on the continuous spectrum at a respective plurality of expected wavelengths;
measuring, with a detector of the optical system, at least one of a detected intensity of the continuous spectrum and a plurality of detected wavelengths of the plurality of discrete emission lines; and
determining, with a processor, at least one of:
an intensity calibration curve over the spectral region based on a closest fit of the detected intensity and the expected intensity of the continuous spectrum, and
a wavelength calibration curve over the spectral region based on a closest fit of the detected wavelength and the expected wavelength of the discrete emission lines.

16. A method as recited in claim 15, wherein the measuring comprises measuring the detected intensity and the plurality of detected wavelengths and wherein the determining comprises determining the intensity calibration curve and the wavelength calibration curve.

17. A method as recited in claim 15, wherein the optical system employs atomic emission spectroscopy and wherein the transmitting step emits radiation from the envelope with a size and shape based on a size and shape of radiation emitted from the sample in the optical system after interaction of the optical signal with the sample.

18. A method as recited in claim 15, further comprising:
disconnecting the plurality of electrodes from the power supply;
removing the optical source from the point of detection of the optical system;
positioning a sample in the point of detection of the optical system;
transmitting the optical signal of the optical system at the sample;
measuring, with the detector of the optical system, at least one of an intensity and a wavelength of radiation emitted from the sample based on the interaction with the optical signal; and
correcting, with the processor, at least one of the measured intensity of the radiation using the intensity calibration curve and the measured wavelength of the radiation using the wavelength calibration curve.

19. An optical source for calibrating an optical system, comprising:
an envelope with a size and a shape to fit a form factor, wherein the form factor is based on a point of detection of the optical system corresponding to a region where an optical signal of the optical system interacts with a sample;
gas within the envelope, wherein the gas has an emission spectrum comprising a continuous spectrum and a plurality of discrete emission lines superimposed on the continuous spectrum in a wavelength range of radiation emitted by the sample in the optical system; and
a first and second electrode connected to respective first and second ends of the envelope and configured to be connected to a power source to provide a voltage difference for ionization the gas between the first and second ends.

20. An optical source as recited in claim 19,
wherein the optical system is a laser induced breakdown spectroscopy (LIBS) system and wherein the point of detection corresponds to an ablated portion of the sample;
and wherein the envelope is a tube formed from fused silica.
